(19) United States
(12) Patent Application Publication
(10) Pub. No.: US 2011/0115136 A1
(43) Pub. Date: May 19, 2011

(54) MANUFACTURING METHOD OF HONEYCOMB STRUCTURAL BODY

(75) Inventors: Masafumi KUNIEDA, Ibi-Gun (JP); Yosuke Matsukawa, Ibi-Gun (JP)

(73) Assignee: IBIDEN CO., LTD., Ogaki-Shi (JP)

(21) Appl. No.: 12/884,105

(22) Filed: Sep. 16, 2010

(30) Foreign Application Priority Data
Nov. 19, 2009 (JP) PCT/JP2009/069662

(51) Int. Cl. C04B 35/64

(52) U.S. Cl. 264/631

(57) ABSTRACT

A method of manufacturing a honeycomb structural body includes performing a heat treatment on zeolite particles that have undergone an iron ion-exchange. The heat treatment is performed in a non-oxygenated atmosphere having a temperature within a range of approximately 500° C. through approximately 800° C. to obtain heat-treated zeolite particles. A honeycomb molded body is formed from a raw material including the heat-treated zeolite particles. The honeycomb molded body is fired to manufacture a honeycomb unit. The honeycomb structural body includes the honeycomb unit including plural cells extending from a first end face to a second end face in a longitudinal direction. The plural cells are partitioned by cell walls.

### CROSS-REFERENCE TO RELATED APPLICATION

The present application claims priority under 35 U.S.C. §119 to International Application No. PCT/JP2009/069662, filed on Nov. 19, 2009. The contents of this application are incorporated herein by reference in their entirety.

### BACKGROUND OF THE INVENTION

1. Field of the Invention

The present invention relates to a method of manufacturing a honeycomb structural body.

2. Discussion of Background

Many techniques have been developed for purifying (converting) exhaust gas that is discharged from automobiles. However, as the traffic volume is increasing, the conventional measures for countering exhaust gas are becoming insufficient. Both domestically and internationally, exhaust gas regulations are being increasingly intensified. Regulations on NOx in diesel exhaust gas are particularly being intensified. Conventionally, NOx has been reduced by controlling the engine's combustion system; however, this measure is becoming insufficient. In order to counter such problems, an NOx reduction system that is implemented by adding a urea aqueous solution (referred to as a urea SCR system) has been proposed as a diesel NOx conversion system. A honeycomb structural body is known as the catalyst carrier used in this system.

For example, a honeycomb structural body has plural cells (through holes) extending from one end face to the other end face of the honeycomb structural body in a longitudinal direction. These cells are partitioned from each other by cell walls supporting a catalyst. Accordingly, when exhaust gas flows through the honeycomb structural body, the NOx included in the exhaust gas is converted by the catalyst supported on the cell walls, and therefore the exhaust gas can be treated.

Generally, such a honeycomb structural body is formed with cordierite. Furthermore, the cell walls support a catalyst such as zeolite (that has undergone ion-exchange with iron, copper, or the like). The honeycomb structural body itself may be formed with zeolite (see, for example, JP61-171539A).

Contents of JP61-171539A are incorporated herein by reference in their entirety.

### SUMMARY OF THE INVENTION

According to one aspect of the present invention, a method of manufacturing a honeycomb structural body includes performing a heat treatment on zeolite particles that have undergone an iron ion-exchange. The heat treatment is performed in a non-oxygenated atmosphere having a temperature within a range of approximately 500° C. through approximately 800° C. to obtain heat-treated zeolite particles. A honeycomb molded body is formed from a raw material including the heat-treated zeolite particles. The honeycomb molded body is fired to manufacture a honeycomb unit. The honeycomb structural body includes the honeycomb unit including plural cells extending from a first end face to a second end face in a longitudinal direction. The plural cells are partitioned by cell walls.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein;

FIG. 1 is a schematic perspective view of an example of a honeycomb structural body according to an embodiment of the present invention;

FIG. 2 is a schematic perspective view of a honeycomb unit forming the honeycomb structural body shown in FIG. 1;

FIG. 3 is an example flowchart of a method of manufacturing a honeycomb structural body according to an embodiment of the present invention; and

FIG. 4 is a schematic perspective view of other example of a honeycomb structural body according to an embodiment of the present invention.

### DESCRIPTION OF THE EMBODIMENTS

The honeycomb structural body used in the urea SCR system is manufactured as follows. First, a honeycomb molded body is extruded from a raw material paste including zeolite as inorganic particles, an inorganic binder, and inorganic fiber as a reinforcement material. Then, the honeycomb molded body is subjected to a firing process. The zeolite has undergone ion-exchange by combining the aluminum sites (Al⁻) in the zeolite with iron ions (Fe³⁺), in order to cause a NOx reduction reaction. The urea SCR system is required to have high NOx conversion efficiency with a smaller volume. Therefore, a larger amount of iron ions (Fe³⁺) are preferably used to perform ion-exchange on the aluminum sites (Al⁻) in the zeolite.

According to an embodiment of the present invention, a honeycomb structural body having high NOx conversion performance may be provided.

The embodiments will now be described with reference to the accompanying drawings, wherein like reference numerals designate corresponding or identical elements throughout the various drawings.

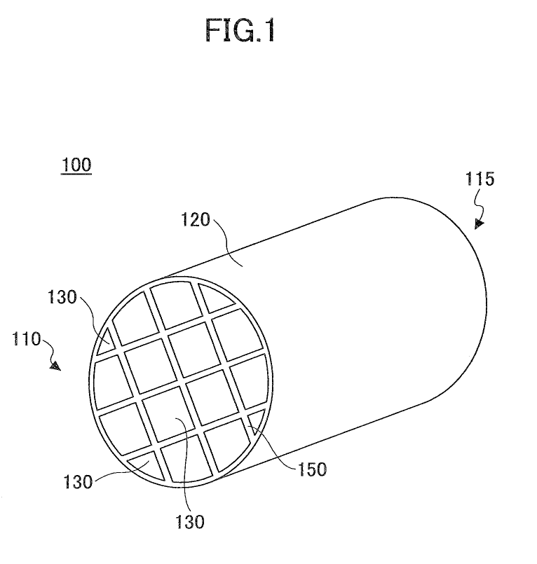

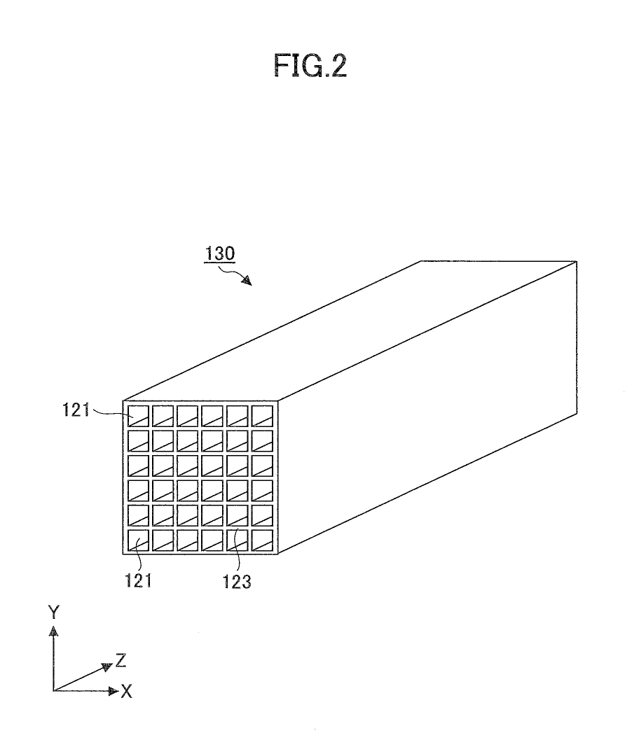

FIG. 1 schematically illustrates an example of a honeycomb structural body used as a catalyst carrier for NOx conversion, according to an embodiment of the present invention. FIG. 2 illustrates an example of a honeycomb unit that is a basic unit of the honeycomb structural body shown in FIG. 1.

As shown in FIG. 1, a honeycomb structural body 100 has two end faces 110 and 115. The peripheral surface of the honeycomb structural body 100 is provided with a coat layer 120 such that the coat layer 120 is not provided on the two end faces.

The following describes an example of how the honeycomb structural body 100 is formed. FIG. 2 illustrates a pillar-shaped honeycomb unit 130 made of ceramics. Plural honeycomb units 130 (the example shown in FIG. 1 includes four horizontal rows and four vertical rows, i.e., a total of 16 honeycomb units) are joined together by interposing adhesive layers 150. Then, the periphery is cut into a predetermined shape (a cylindrical shape in the example shown in FIG. 1).

As shown in FIG. 2, the honeycomb unit 130 has plural cells (through holes) 121 that are open at both end faces, and that extend in a longitudinal direction from one end to the other end of the honeycomb unit 130. Furthermore, the cells 121 are partitioned by cell walls 123. In the example shown in FIG. 2, a cross-sectional shape perpendicular to the longitudinal direction (Z direction) of the cell 121 is a substantially square shape, although the present invention is not so limited.

The honeycomb structural body 100 having the above configuration is used as a catalyst carrier of a urea SCR system having a urea tank, for example.

The honeycomb unit 130 is formed with zeolite that has undergone iron ion-exchange (ion-conversion). The zeolite functions as a catalyst for NOx conversion reaction. Accordingly, when exhaust gas flows through a urea SCR system including the honeycomb structural body 100 functioning as a catalyst carrier, the urea in a urea tank reacts to the water in the exhaust gas, and ammonia is generated (formula (1)).

CO(NH₂)₂+H₂O→2NH₃+CO₂ formula (1)

When the generated ammonia flows into the cells together with the exhaust gas including NOx from one of the end faces of the honeycomb structural body 100 (for example, the end face 110), the reactions expressed by formula (2-1) and formula (2-2) occur due to the function of the catalyst in the zeolite.

4NH₃+4NO+O₂→4N₂+6H₂O formula (2-1)

8NH₃+6NO₂→7N₂+12H₂O formula (2-2)

Then, the exhaust gas that has been converted is discharged from the another end face of the honeycomb structural body 100 (for example, the end face 115). By making the exhaust gas flow through the honeycomb structural body 100, the NOx in the exhaust gas can be treated.

When manufacturing a honeycomb structural body by extruding a honeycomb molded body from a raw material paste including zeolite as inorganic particles, an inorganic binder, and inorganic fiber as a reinforcement material, and performing firing process on the honeycomb molded body, the zeolite included in the raw material has the following feature. Specifically, the zeolite has undergone ion-exchange by combining the aluminum sites (Al⁻) in the zeolite with iron ions (Fe³⁺). The zeolite has undergone the ion-exchange for the purpose of causing NOx reduction reaction.

The aluminum sites of the zeolite are required to undergo ion-exchange by using a larger amount of iron ions. Typically, when the zeolite raw material is subjected to ion-exchange, the iron ions (Fe³⁺) tend to not be sufficiently fixed to the aluminum sites (Al⁻). Thus, in a subsequent heat treatment, the iron ions (Fe³⁺) may turn into iron oxide (Fe₂O₃), such that iron oxide tends to be formed on the zeolite particles.

When the iron ions (Fe³⁺) are formed on the zeolite particles as iron oxide (Fe₂O₃), the iron ions (Fe³⁺) contribute less to the NOx conversion reaction. Accordingly, a honeycomb structural body (honeycomb unit) that is formed with such a raw material tends to have low NOx conversion efficiency.

Given such a background, the inventors of the present invention contrived the present invention by finding that the honeycomb structural body 100 may have relatively high NOx conversion efficiency if the honeycomb units 130 and the honeycomb structural body 100 are manufactured with the use of zeolite particles that have undergone a predetermined pretreatment. Accordingly, an embodiment of the present invention provides a method of manufacturing a honeycomb structural body including at least one honeycomb unit including plural cells extending from a first end face to a second end face in a longitudinal direction, the plural cells being partitioned by cell walls, the at least one honeycomb unit including zeolite particles that have undergone iron ion-exchange, the method including (a) a step of performing a heat treatment on the zeolite particles that have undergone the iron ion-exchange, the heat treatment being performed in a non-oxygenated atmosphere having a temperature within a range of approximately 500° C. through approximately 800° C., to obtain heat-treated zeolite particles; (b) a step of forming at least one honeycomb molded body from a raw material including the heat-treated zeolite particles; and (c) a step of manufacturing the at least one honeycomb unit by firing the at least one honeycomb molded body.

In the manufacturing method according to an embodiment of the present invention, the zeolite particles in the prepared raw material have undergone a heat treatment in a non-oxygenated atmosphere having a temperature within a range of approximately 500° C. through approximately 800° C. In this case, even if the zeolite particles in the prepared raw material have many iron ions (Fe³⁺) that are not combined with aluminum sites (Al⁻) of the zeolite, such iron ions (Fe³⁺) tend to be fixed to many aluminum sites (Al⁻) in the zeolite as a result of the heat treatment. Thus, by manufacturing the honeycomb units with these zeolite particles that have undergone the heat treatment, the honeycomb units tend to have an increased number of reaction sites (iron ion-exchange positions) that contribute to the NOx conversion reaction. Consequently, the resultant honeycomb units and honeycomb structural body have high NOx conversion performance.

A detailed description is given of a method of manufacturing a honeycomb structural body according to an embodiment of the present invention.

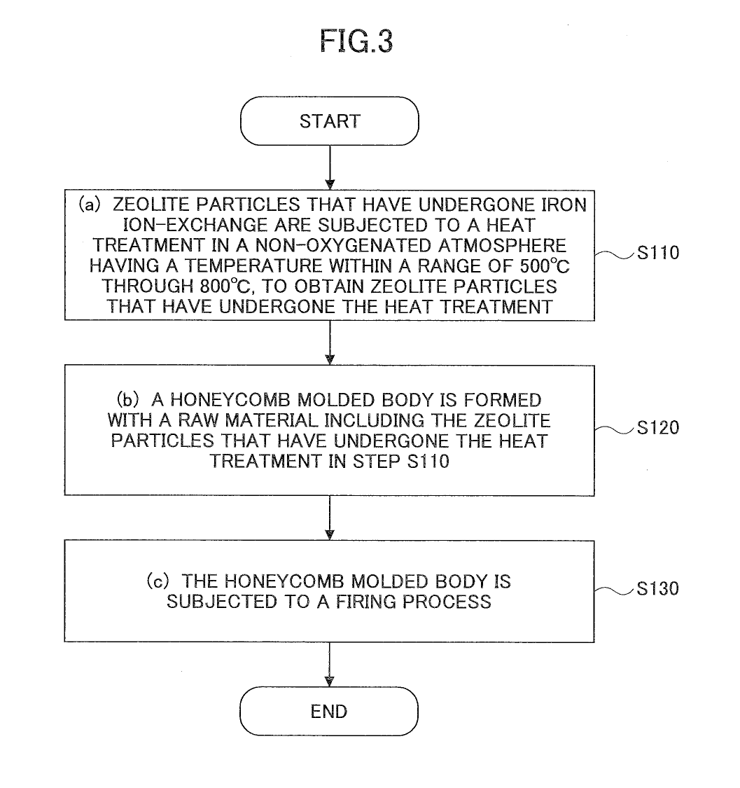

FIG. 3 is an example flowchart of a method of manufacturing a honeycomb structural body according to an embodiment of the present invention. The method of manufacturing a honeycomb structural body includes the following steps.
(a) Zeolite particles that have undergone iron ion-exchange are subjected to a heat treatment in a non-oxygenated atmosphere having a temperature within a range of approximately 500° C. through approximately 800° C., to obtain zeolite particles that have undergone the heat treatment (step S110).
(b) A honeycomb molded body is formed with a raw material including the zeolite particles that have undergone the heat treatment (step S120).
(c) The honeycomb molded body is subjected to a firing process, so that a honeycomb unit is manufactured (step S130).

Details of each of the above steps are given below.

### (Step S110)

First, zeolite particles, which have undergone iron ion-exchange, are prepared. The zeolite particles may include free iron ions (Fe³⁺) that are not combined with aluminum sites (Al⁻) in the zeolite.

Next, the zeolite particles are subjected to a heat treatment in a non-oxygenated atmosphere (an atmosphere in which the oxygen partial pressure is less than or equal to approximately 0.1%). The non-oxygenated atmosphere includes an inert gas atmosphere such as a nitrogen atmosphere and an argon atmosphere, and a vacuum environment. The temperature of the heat treatment is preferably within a range of approximately 500° C. through approximately 800° C., more preferably in a range of approximately 700° C. through approximately 750° C. The duration of the heat treatment is preferably approximately 0.5 hours through approximately 5 hours.

Accordingly, the free iron ions (Fe³⁺) in the zeolite particles are combined with the aluminum sites (Al⁻).

Before performing the heat treatment, a drying process is preferably performed; however, when the drying process is not performed, the heat treatment is preferably performed at approximately 120° C. through approximately 250° C. for approximately 3 hours through approximately 24 hours.

### (Step S120)

Next, a honeycomb molded body is formed with a raw material including the zeolite particles that have undergone the heat treatment.

First, the zeolite particles that have undergone the heat treatment are mixed with an inorganic binder to prepare a raw material paste.

Examples of the inorganic binder are alumina sol, silica sol, titania sol, liquid glass, white clay, kaolin, montmorillonite, sepiolite, attapulgite, boehmite, or the like. These can be used alone or in combination.

The inorganic binder is preferably at least one kind selected from a group consisting of alumina sol, silica sol, titania sol, liquid glass, sepiolite, attapulgite, and boehmite.

The lower limit of the amount of zeolite included in a honeycomb unit is preferably approximately 30 wt %, more preferably approximately 40 wt %, and still more preferably approximately 50 wt %. Meanwhile, the preferable upper limit is approximately 90 wt %, more preferably approximately 80 wt %, and still more preferably approximately 75 wt %. If the content of zeolite were more than or equal to approximately 30 wt %, the amount of zeolite that can contribute to converting NO_{X} tends to not become relatively small. Meanwhile, if the content of zeolite is less than or equal to approximately 90 wt %, the strength of the honeycomb unit tends to not be reduced.

The amount of the inorganic binder included in a honeycomb unit as solids content is preferably more than or equal to approximately 5 wt %, more preferably more than or equal to approximately 10 wt %, and still more preferably more than or equal to approximately 15 wt %. Meanwhile, the amount of the inorganic binder included in a honeycomb unit as solids content is preferably less than or equal to approximately 50 wt %, more preferably less than or equal to approximately 40 wt %, and still more preferably less than or equal to approximately 35 wt %. If the content of the inorganic binder as solids content were more than or equal to than approximately 5 wt %, the strength of the manufactured honeycomb unit tends to not be reduced. Meanwhile, if the content of the inorganic binder as solids content is less than or equal to approximately 50 wt %, the moldability of the raw material composition tends to not be degraded.

Furthermore, according to need, inorganic fiber and/or an inorganic flaky substance may be added to the raw material paste.

Examples of inorganic fiber materials are alumina, silica, silicon carbide, silica alumina, glass, potassium titanate, aluminum borate and the like. These can be used alone or in combination.

An inorganic flaky substance is different from inorganic fiber. The inorganic flaky substance is an inorganic additive that has a flaky shape. The inorganic flaky substance preferably has a thickness within a range of approximately 0.2 μm through approximately 5 μm, a maximum length within a range of approximately 10 μm through approximately 160 μm, and an aspect ratio (thickness/maximum length) within a range of approximately 3 through approximately 250. The thickness and the maximum length of the inorganic flaky substance are average values obtained from SEM photographs. The thickness of the inorganic flaky substance is the average value obtained from twenty inorganic flaky substances. The maximum length of the inorganic flaky substance is the average value obtained from twenty inorganic flaky substances, based on a maximum diameter when the inorganic flaky substance is approximated to a flat particle.

The inorganic flaky substances are preferably at least one kind selected from a group consisting of glass flakes, mica flakes, alumina flakes, silica flakes, and zinc oxide flakes.

The inorganic fiber or inorganic flaky substances function as strength reinforcement materials, so that the strength of the honeycomb unit tends to increase.

When a honeycomb unit includes inorganic fiber and inorganic flaky substances, the lower limit of the total amount of inorganic fiber and inorganic flaky substances in a honeycomb unit is preferably approximately 3 wt %, more preferably approximately 5 wt %, and still more preferably approximately 8 wt %. Meanwhile, the preferable upper limit is approximately 50 wt %, more preferably approximately 40 wt %, and still more preferably approximately 30 wt %. If the total amount of inorganic fiber and inorganic flaky substances were more than or equal to approximately 3 wt %, the strength of the honeycomb unit tends to be sufficient. Meanwhile, if the total amount of inorganic fiber and inorganic flaky substances is less than or equal to approximately 50 wt %, the amount of zeolite that can contribute to converting NO_{X} tends to not become relatively small.

Other than the above components, an organic binder, a dispersion medium, and a molding aid may be appropriately added to the raw material paste, according to the moldability. As the organic binder, one or more organic binders may be selected from methylcellulose, carboxyl methylcellulose, hydroxyethylcellulose, polyethylene glycol, phenolic plastic, epoxy resin, or the like, although not particularly limited thereto. The blending quantity of the organic binder is preferably approximately 1 part by weight through approximately 10 parts by weight with respect to a total of 100 parts by weight of inorganic particles, an inorganic binder, inorganic fiber, and inorganic flaky substances.

Examples of the dispersion medium are water, an organic solvent (e.g., benzene), alcohol (methanol) and the like, although not particularly limited thereto. Examples of the molding aid are ethylene glycol, dextrin, fatty acid, fatty acid soap, polyalcohol and the like, although not particularly limited thereto.

The raw material paste is preferably mixed by using a mixer, an attritor or the like to mix it, and is also preferably kneaded by using a kneader or the like to sufficiently knead it, although not particularly limited thereto. For example, an extrusion molding method is a preferable method for molding the raw material paste into a shape having cells, although the method is not particularly limited thereto.

Next, the resultant honeycomb molded body is dried to manufacture a honeycomb dried body. Examples of a drying apparatus used for the drying process are a microwave drying apparatus, a hot air drying apparatus, a dielectric drying apparatus, a suction drying apparatus, a vacuum drying apparatus, a freeze drying apparatus and the like, although not particularly limited thereto.

The resultant honeycomb dried body is preferably degreased. The degreasing conditions are preferably approximately 400° C. for approximately two hours, although these conditions are not particularly limited thereto; the conditions are to be appropriately selected depending on the kind and amount of the organic substances included in the molded body.

### (Step S130)

Next, the honeycomb degreased body formed in the above step is fired to manufacture a honeycomb unit (honeycomb fired body). The firing conditions are preferably approximately 600° C. through approximately 1200° C., more preferably approximately 700° C. through approximately 1000° C., although not particularly limited thereto. This is because if the firing temperature were more than or equal to approximately 600° C., the sintering tends to progress, and therefore the honeycomb unit tends to not have a low level of strength; if the firing temperature were less than or equal to approximately 1200° C., the sintering tends to not progress excessively, and therefore the exhaust gas conversion efficiency tends to not be reduced.

The cell density of the honeycomb unit 130 is preferably within a range of approximately 15.5 cells/cm² through approximately 186 cells/cm² (approximately 100 cpsi through approximately 1200 cpsi), more preferably within a range of approximately 46.5 cells/cm² through approximately 170 cells/cm² (approximately 300 cpsi through approximately 1,100 cpsi), and still more preferably within a range of approximately 62.0 cells/cm² through approximately 155 cells/cm² (approximately 400 cpsi through approximately 1000 cpsi).

The thickness of the cell walls 123 of the honeycomb unit 130 is not particularly limited; however, the preferable lower limit is approximately 0.1 mm in consideration of the strength, and the preferable upper limit is approximately 0.4 mm in consideration of NOx conversion performance.

Next, a paste for adhesive layers which later becomes the adhesive layers is applied onto the side surfaces of honeycomb units formed by the above steps, in such a manner as to have uniform thicknesses. Sequentially, the honeycomb units are stacked onto each other with adhesive layers interposed therebetween. This procedure is repeated to manufacture an assembly of honeycomb units of a desired size (for example, with four horizontal rows and four vertical rows of honeycomb units).

As the paste for adhesive layers, it is possible to use a mixture of inorganic particles and an inorganic binder, a mixture of an inorganic binder and inorganic fiber, a mixture of inorganic particles, an inorganic binder and an inorganic fiber, or the like, although not particularly limited thereto. It is also possible to add an organic binder to this paste for adhesive layers. The above-described inorganic flaky substances may be added to the paste for adhesive layers.

As the inorganic particles, the inorganic binder, the inorganic fiber, and the inorganic flaky substances, the same materials as those used to form the honeycomb unit described above may be used. As an example of the organic binder, one or more kinds of organic binder may be selected from polyvinyl alcohol, methylcellulose, ethyl cellulose, carboxyl methylcellulose, or the like, although not particularly limited thereto.

The thickness of the adhesive layer for joining the honeycomb units is preferably approximately 0.3 mm through approximately 2 mm. If the thickness of the adhesive layer were more than or equal to approximately 0.3 mm, the bonding strength tends to be sufficient. If the thickness were less than or equal to approximately 2 mm, the pressure loss tends to not be large. The number of honeycomb units to be joined together is appropriately selected according to the size of the honeycomb structural body.

Next, the assembly of honeycomb units is heated to dry and solidify the paste for adhesive layers, thereby forming the adhesive layers and fixing together the honeycomb units.

Next, a diamond cutter is used to cut the assembly of honeycomb units into a cylindrical shape. A paste for coat layer which later becomes a coat layer is applied to the peripheral surface (side surface). Then, the paste for coat layer is dried and solidified to form a coat layer. Accordingly, a honeycomb structural body having the required peripheral shape is manufactured.

The paste for coat layer may have the same composition as that of the paste for adhesive layers described above. The thickness of the coat layer is preferably approximately 0.1 mm through approximately 2.0 mm.

By performing the above steps, the honeycomb structural body 100 shown in FIG. 1 is manufactured.

The above describes a method of manufacturing an example of the honeycomb structural body 100 that is formed by joining together plural honeycomb units 130 by interposing the adhesive layers 150. However, the configuration of the honeycomb structural body is not so limited.

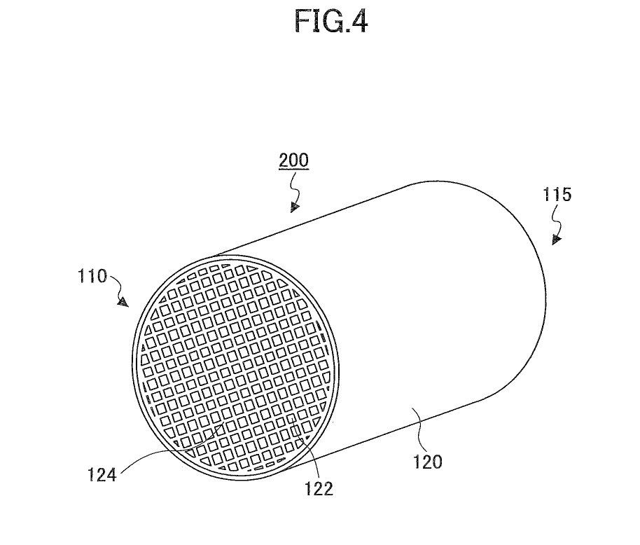

FIG. 4 illustrates other example of a honeycomb structural body according to an embodiment of the present invention. As shown in FIG. 4, a honeycomb structural body 200 is formed of a single honeycomb unit in which plural cells 122, which are partitioned by cell walls 124, are arranged in a longitudinal direction. In the example shown in FIG. 4, the coat layer 120 is applied on the peripheral surface of the honeycomb structural body 200; however, this coat layer 120 may or may not be applied. It is obvious to those skilled in the art that the manufacturing method according to an embodiment of the present invention is also applicable to the honeycomb structural body 200 having the above configuration.

### EXAMPLES

In the following, an embodiment of the present invention is described in detail with examples.

### Example 1

Zeolite particles (particle size 2 μm) that have undergone iron ion-exchange were retained in a temperature of 200° C. for 12 hours and dried. Next, the zeolite particles were subjected to a heat treatment in a non-oxygenated atmosphere having an oxygen density of 0.1%. The heat treatment was performed at 700° C. for two hours.

Next, a mixed composition was obtained by mixing together and kneading 3000 parts by weight of the zeolite particles that have undergone the heat treatment, 650 parts by weight of alumina fiber, 840 parts by weight of an inorganic binder (boehmite), 330 parts by weight of an organic binder (methylcellulose), 330 parts by weight of a lubricant (oleic acid), and 1800 parts by weight of ion-exchange water.

Next, honeycomb molded bodies were extruded from the mixed composition with an extrusion molding apparatus, and the honeycomb molded bodies were sufficiently dried with a microwave drying apparatus and a hot air drying apparatus, so that pillar-shaped honeycomb molded bodies as shown in FIG. 2 were formed.

Subsequently, the honeycomb molded bodies were degreased at 400° C. for two hours. Then, the honeycomb molded bodies were fired at 700° C. for two hours. Accordingly, honeycomb units shaped as rectangular pillars were formed (length 34.3 mm×width 34.3 mm×height 150 mm). The thickness of the cell walls 123 of the honeycomb unit was 0.23 mm. The cell density was 93 cells/cm².

Next, on the side surfaces of 16 honeycomb units, a paste for adhesive layers was applied, and an assembly of honeycomb units (four horizontal rows and four vertical rows) was formed.

The paste for adhesive layers was prepared by mixing together and kneading 59.1 wt % of silica having an average particle size of 2 μm, 18.1 wt % of alumina fiber having an average fiber diameter of 6 μm, 14.2 wt % of silica sol including solids content of 30 weight % as a solid component including an inorganic binder, 0.4 wt % of carboxyl methylcellulose as an organic binder, 3.9 wt % of a water retention agent (polyvinyl alcohol), 3.9 wt % of a surface-active agent, and 0.4 wt % of a foaming agent (alumina balloons).

The thickness of the adhesive layers formed by paste was 2 mm.

Next, the assembly of honeycomb units was heated at 150° C. to dry and solidify the paste for adhesive layers, and the adhesive layers were formed and the honeycomb units were joined to each other. Subsequently, a diamond cutter was used to cut the assembly of honeycomb units into a cylindrical shape, and a cylindrical honeycomb structural body, having a diameter of 141.8 mm and a total length of 150 mm, was manufactured.

Next, a paste for coat layer which later becomes a coat layer was applied to the peripheral surface (side surface) of the honeycomb structural body, thus forming a coat layer having a thickness of 1 mm. The paste for coat layer was dried and solidified and a coat layer was formed. The same paste as the paste for adhesive layers was used as the paste for coat layer.

By performing the above procedure, a cylindrical honeycomb structural body (honeycomb structural body of example 1) was manufactured, having a diameter of 143.8 mm and a total length of 150 mm as shown in FIG. 1.

### Example 2

A honeycomb structural body according to example was manufactured by the same procedures as that of example 1. However, in example 2, after the zeolite particles that have undergone iron ion-exchange (particle sizes 2 μm) were retained in a temperature of 200° C. for 12 hours and dried, the zeolite particles were subjected to a heat treatment in a non-oxygenated atmosphere having an oxygen density of 0.05%. The other manufacturing conditions were the same as those of example 1.

### Example 3

A honeycomb structural body according to example 3 was manufactured by the same procedures as that of example 1. However, in example 3, after the zeolite particles that have undergone iron ion-exchange (particle sizes 2 μm) were retained in a temperature of 200° C. for 12 hours and dried, the zeolite particles were subjected to a heat treatment at 500° C. for two hours. The other manufacturing conditions were the same as those of example 1.

### Example 4

A honeycomb structural body according to example 4 was manufactured by the same procedures as that of example 1. However, in example 4, after the zeolite particles that have undergone iron ion-exchange (particle sizes 2 μm) were retained in a temperature of 200° C. for 12 hours and dried, the zeolite particles were subjected to a heat treatment at 800° C. for two hours. The other manufacturing conditions were the same as those of example 1.

### Comparative Example 1

A honeycomb structural body according to comparative example 1 was manufactured by the same procedures as that of example 1. However, in comparative example 1, the zeolite particles that have undergone iron ion-exchange (particle sizes 2 μm) were directly used as the raw material (i.e., a drying process and a heat treatment were not performed). The other manufacturing conditions were the same as those of example 1.

Table 1 indicates the drying and heating conditions of the zeolite particles that have undergone iron ion-exchange for the respective examples and the comparative example.

TABLE 1

| | PRETREATMENT OF | | | |
|---|---|---|---|---|
| | ZEOLITE PARTICLES | | | CONVER- |
| | HEAT TREATMENT CONDITIONS | | | SION |
| | OXYGEN | TEMPER- | | EFFI- |
| | DENSITY | ATURE | TIME | CIENCY |
| | (%) | (° C.) | (hr) | (%) |
| EXAMPLE 1 | 0.1 | 700 | 2 | 60 |
| EXAMPLE 2 | 0.05 | 700 | 2 | 58 |
| EXAMPLE 3 | 0.1 | 500 | 2 | 58 |
| EXAMPLE 4 | 0.1 | 800 | 2 | 56 |
| COMPARATIVE | — | — | — | 43 |
| EXAMPLE 1 | | | | |

### (Evaluation of NOx Conversion Performance)

The honeycomb units included in the honeycomb structural bodies manufactured according to examples 1 through 4 and comparative example 1 were cut into rectangular pillars (34.3 mm×34.3 mm×40 mm) and used as evaluation samples. The evaluation samples were used to evaluate the NOx conversion performance.

The NOx conversion performance was evaluated by using test gas, which is simulated gas based on driving conditions of a diesel engine of an automobile. The test gas was made to flow through the honeycomb units, NOx processing was performed, and the amount of NO (nitric oxide) included in the gas discharged from the honeycomb structural body was measured.

The composition of the test gas included 175 ppm of nitric oxide, 175 ppm of nitrogen dioxide, 350 ppm of ammonia, 14 volume % of oxygen, 5 volume % of carbon dioxide, 10 volume % of water, and nitrogen (balance).

The NOx conversion performance was continued until the NO density in the test gas discharged from the honeycomb structural body did not change much any longer (before and after flowing through the honeycomb structural body). An apparatus (MEXA-7100D) manufactured by HORIBA was used for measuring the NO density. The detection limit of NO of this apparatus was 0.1 ppm. The detection temperature was 200° C., which was fixed while the test was being performed.

A NOx conversion efficiency “N” was calculated from the measurement results. The NOx conversion efficiency “N” was calculated by formula (3).

N(%)={(NO density in mixed gas before being injected in evaluation sample−NO density in exhaust gas discharged from evaluation sample)}/(NO density in mixed gas before being injected in evaluation sample)×100 formula (3)

The evaluation results of the NOx conversion performance are indicated in the right column of table 1. Based on these results, it is found that the honeycomb structural bodies (examples 1 through 4) according to an embodiment of the present invention have high NOx conversion efficiency compared to the honeycomb structural body according to comparative example 1.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A method of manufacturing a honeycomb structural body, the method comprising:
performing a heat treatment on zeolite particles that have undergone an iron ion-exchange, the heat treatment being performed in a non-oxygenated atmosphere having a temperature within a range of approximately 500° C. through approximately 800° C. to obtain heat-treated zeolite particles;
forming a honeycomb molded body from a raw material including the heat-treated zeolite particles; and
firing the honeycomb molded body to manufacture a honeycomb unit, the honeycomb structural body comprising the honeycomb unit including plural cells extending from a first end face to a second end face in a longitudinal direction, the plural cells being partitioned by cell walls.

2. The method according to claim 1, wherein
the non-oxygenated atmosphere comprises a nitrogen atmosphere.

3. The method according to claim 1, wherein
the firing step is performed at a temperature within a range of approximately 700° C. through approximately 1000° C.

4. The method according to claim 1, wherein
the raw material further comprises an inorganic binder, and at least one of an inorganic fiber and an inorganic flaky substance.

5. The method according to claim 4, wherein
the inorganic binder comprises at least one of alumina sol, silica sol, titania sol, liquid glass, sepiolite, attapulgite, and boehmite.

6. The method according to claim 4, wherein
the inorganic fiber comprises at least one of alumina, silica, silicon carbide, silica alumina, glass, potassium titanate, and aluminum borate.

7. The method according to claim 4, wherein
the inorganic flaky substance comprises at least one of a glass flake, a mica flake, an alumina flake, a silica flake, and a zinc oxide flake.

8. The method according to claim 1, further comprising:
after the firing step, joining together plural of honeycomb units via adhesive layers to form an assembly having a predetermined shape.

9. The method according to claim 1, wherein
the honeycomb structural body comprises a single honeycomb unit.

10. The method according to claim 1, further comprising:
providing a coat layer on a peripheral surface of the honeycomb structural body such that the coat layer is not provided on the first end face and the second end face.

11. The method according to claim 8, wherein
the joining step comprises cutting a periphery of the honeycomb structural body into the predetermined shape after joining together the plural of honeycomb units via the adhesive layers.

12. The method according to claim 1, wherein
the non-oxygenated atmosphere has oxygen partial pressure of less than or equal to approximately 0.1%.

13. The method according to claim 1, wherein
the non-oxygenated atmosphere comprises at least one of a nitrogen atmosphere, an argon atmosphere, and a vacuum environment.

14. The method according to claim 1, wherein
the heat treatment is performed in a temperature of approximately 700° C. through approximately 750° C.

15. The method according to claim 1, wherein
the heat treatment is performed for approximately 0.5 hours through approximately 5 hours.

16. The method according to claim 1, further comprising:
performing a drying process on the zeolite particles that have undergone the iron ion-exchange before the heat treatment is performed.

17. The method according to claim 16, wherein
the drying process is performed at approximately 120° C. through approximately 250° C. for approximately 3 hours through approximately 24 hours.

18. The method according to claim 1, wherein
a lower limit of the heat-treated zeolite particles included in the raw material is approximately 30 wt % and an upper limit of the heat-treated zeolite particles included in the raw material is approximately 90 wt %.

19. The method according to claim 4, wherein
an amount the inorganic binder included in the raw material as solids content is more than or equal to approximately 5 wt % and less than or equal to approximately 50 wt %.

20. The method according to claim 4, wherein
a total amount of the inorganic fiber and the inorganic flaky substance has a lower limit of approximately 3 wt % and an upper limit of 50 wt %.

21. The method according to claim 1, wherein
the firing step is performed within a range of approximately 600° C. through approximately 1200° C.

22. The method according to claim 1, wherein
the honeycomb structural body is so constructed as to be used as a catalyst in a urea SCR system.
